(19) United States
(12) Patent Application Publication
(10) Pub. No.: US 2013/0036681 A1
(43) Pub. Date: Feb. 14, 2013

(54) Skiddable Blind

(71) Applicant: Raleigh William Baird, III, Houston, TX (US)

(72) Inventor: Raleigh William Baird, III, Houston, TX (US)

(21) Appl. No.: 13/550,286

(22) Filed: Jul. 16, 2012

Related U.S. Application Data
(60) Provisional application No. 61/508,207, filed on Jul. 15, 2011.

(51) Int. Cl. E04H 1/12; E04B 1/348; A01M 31/00; E04B 1/19

(52) U.S. Cl. 52/143; 52/653.1; 52/264; 52/745.2

(57) ABSTRACT

A blind structure with a base, a plurality of rails, a plurality of posts supporting the rails and a skidable member coupled to the base; wherein the skidable member supports the base above the ground. In certain configurations the plurality of posts includes retention means for a plurality of wire mesh sheets that form the walls of the blind structure. In further configurations, at least one wall of the blind structure comprises an automatically closing door.

### CROSS-REFERENCE TO RELATED APPLICATIONS

This application claims the benefit of U.S. Provisional Application Ser. No. 61/508,207 filed on Jul. 15, 2011, entitled “Skiddable Blind” which is hereby incorporated herein by reference in its entirety.

### STATEMENT REGARDING FEDERALLY SPONSORED RESEARCH OR DEVELOPMENT

Not applicable.

### BACKGROUND

1. Field of the Disclosure

This Disclosure relates to outdoor recreation, specifically to hunting or wild game observation.

2. Background of the Disclosure

Observation and hunting of wild game requires concealment or camouflage of a person. Typically, a person dresses in camouflage and remains nearly motionless in an advantageous location. Alternatively, or additionally, a blind or other structure suitable for concealment of a person is positioned in an advantageous location. However, building a blind entirely from natural elements (e.g., branches, brush, native vegetation) is time-consuming and may be difficult to achieve in the location chosen to build the blind. Further, transportation of a pre-built blind to and from the hunting location typically requires a pick-up truck or other large vehicle capable of carrying or towing the blind into position. Further still, traversing rough ground makes towing a blind difficult or impossible in some instances.

### BRIEF SUMMARY

A blind structure comprising a base, having a plurality of sides and a plurality corners, a plurality of rails, a plurality of posts disposed at the plurality of base corners, and supporting the rails vertically thereabove and a skidable member coupled to the base; wherein the skidable member supports the base. In certain configurations the plurality of posts includes retention means for a plurality of wire mesh sheets, wherein the wire mesh sheets form walls of the blind structure. In further configurations, at least one wall of the blind structure comprises an automatically closing door.

The foregoing has outlined rather broadly certain features and characteristics of the disclosed embodiments in order that the detailed description that follows may be better understood. Additional features and characteristics of the exemplary embodiments will be described hereinafter. It should be appreciated by those skilled in the art that the specific embodiments disclosed herein may be readily utilized as a basis for modifying or designing other structures for carrying out the same purposes of the specifically-described, exemplary embodiments, and that such equivalent constructions do not depart from the spirit and scope of the invention as set forth in the appended claims.

### BRIEF DESCRIPTION OF THE DRAWINGS

For a detailed description of the preferred embodiments of the disclosure, reference will now be made to the accompanying drawings in which:

FIG. 1 illustrates a blind according to an exemplary embodiment of the present disclosure.

FIG. 2 illustrates another exemplary configuration according to the disclosure.

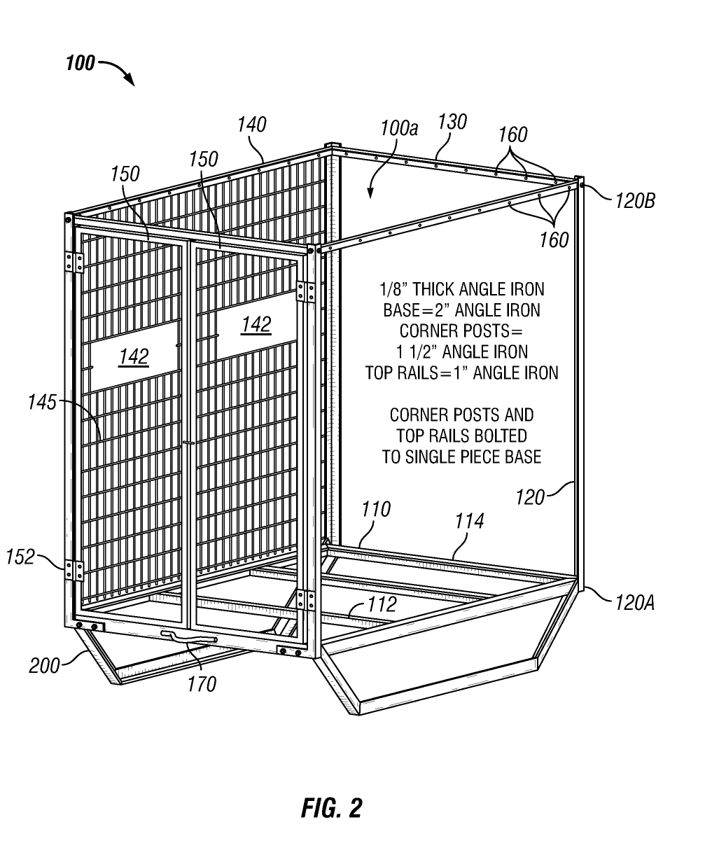

FIG. 3 illustrates another exemplary configuration according to the disclosure.

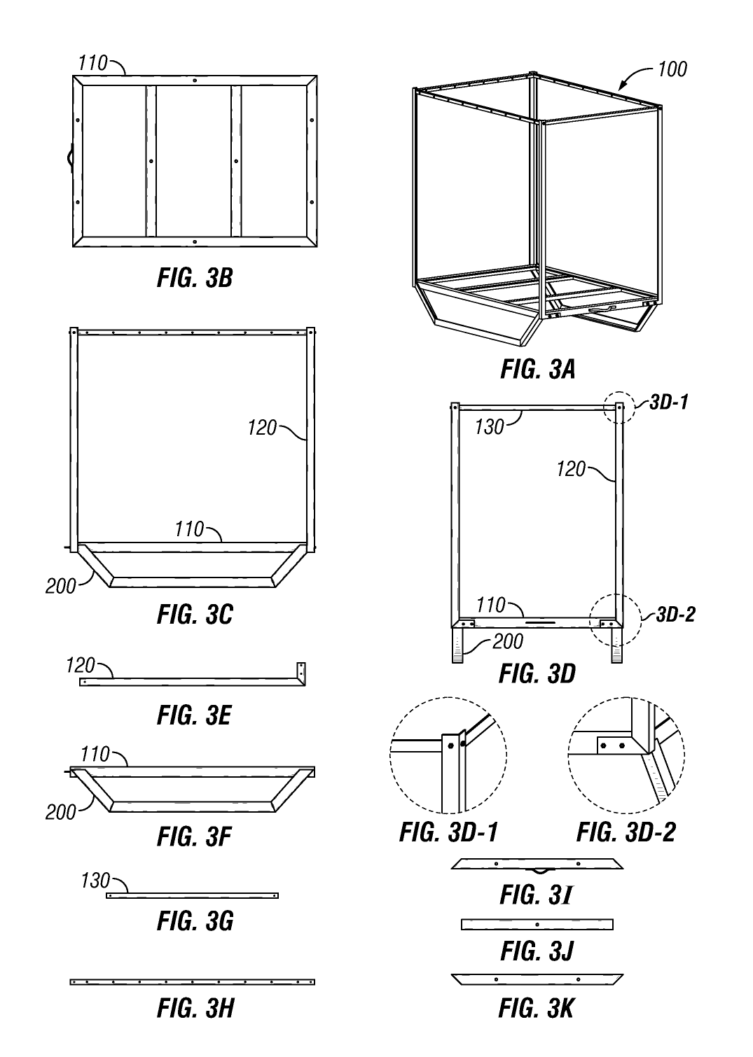

FIG. 4 illustrates another exemplary configuration according to the disclosure.

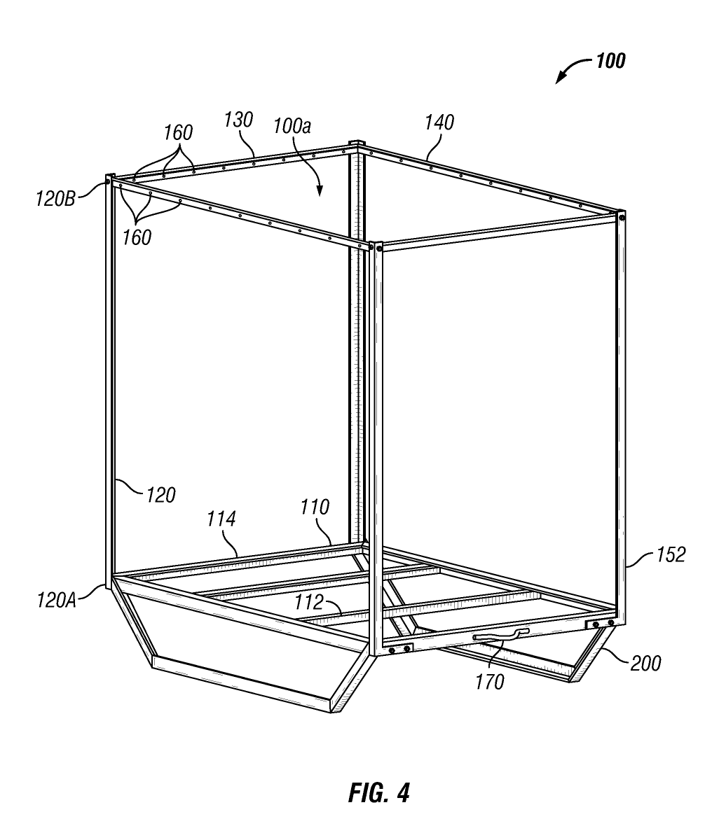

FIG. 5 illustrates another exemplary configuration according to the disclosure.

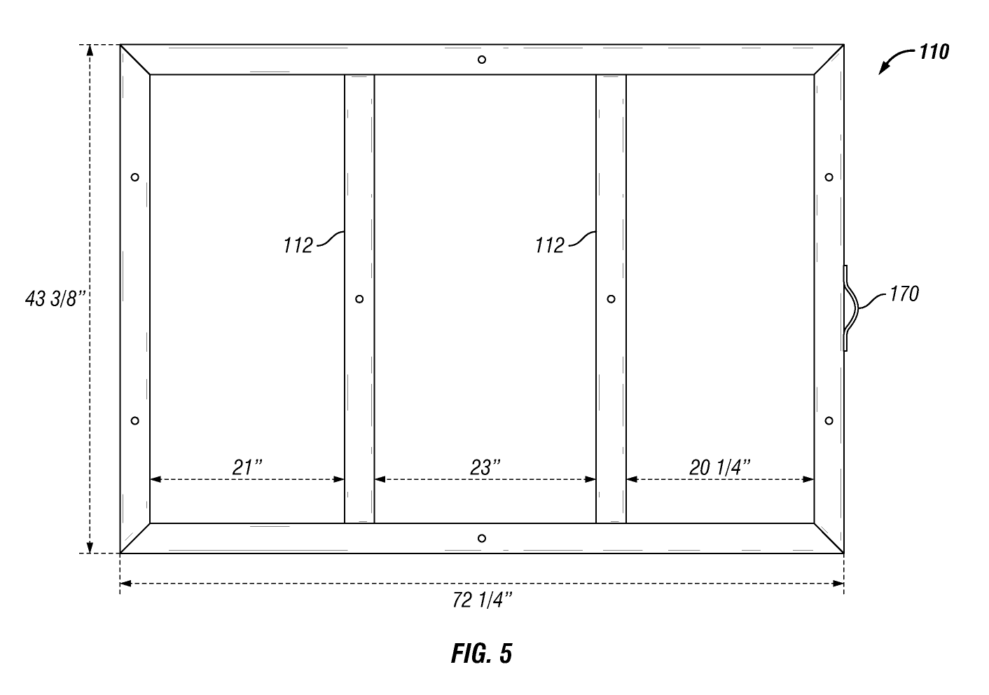

FIG. 6 illustrates another exemplary configuration according to the disclosure.

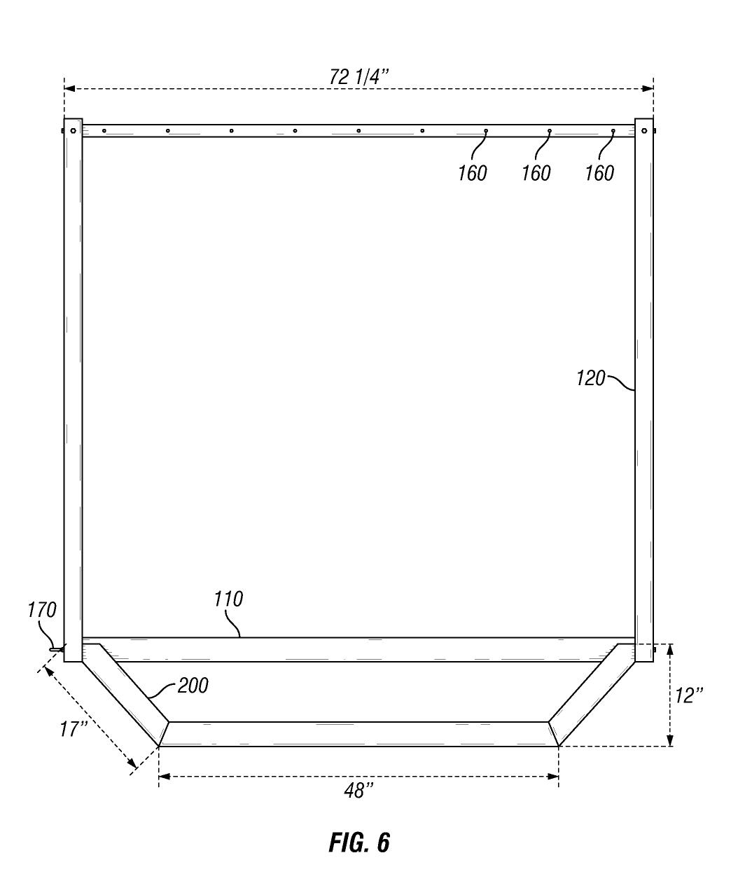

FIG. 7 illustrates another exemplary configuration according to the disclosure.

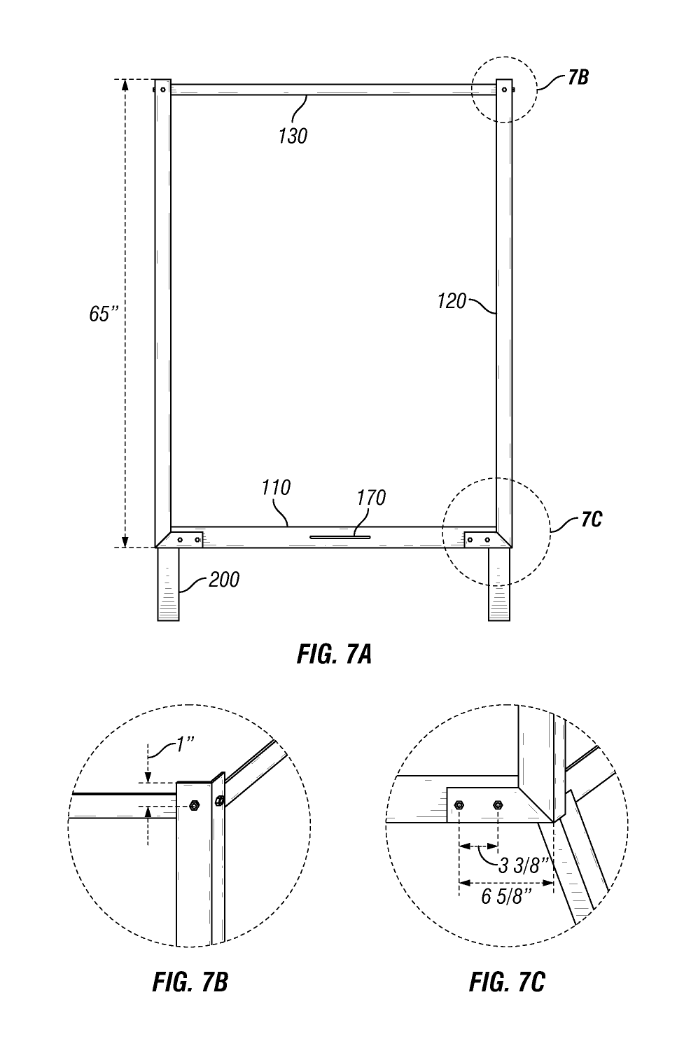

FIG. 8 illustrates another exemplary configuration according to the disclosure.

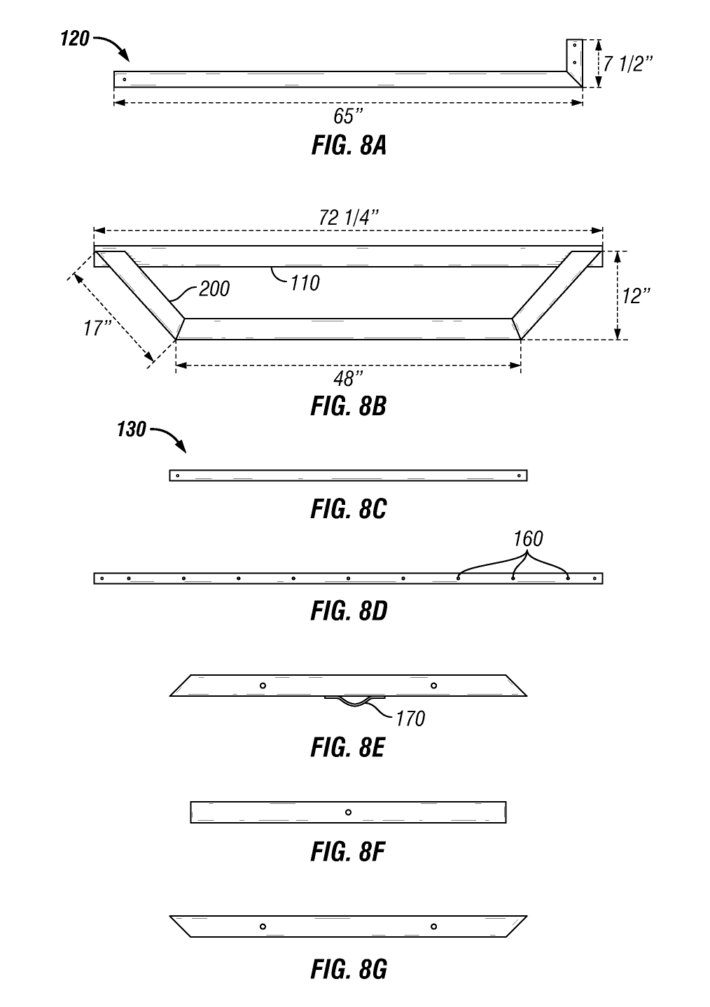

### DETAILED DESCRIPTION OF THE DISCLOSED EMBODIMENTS

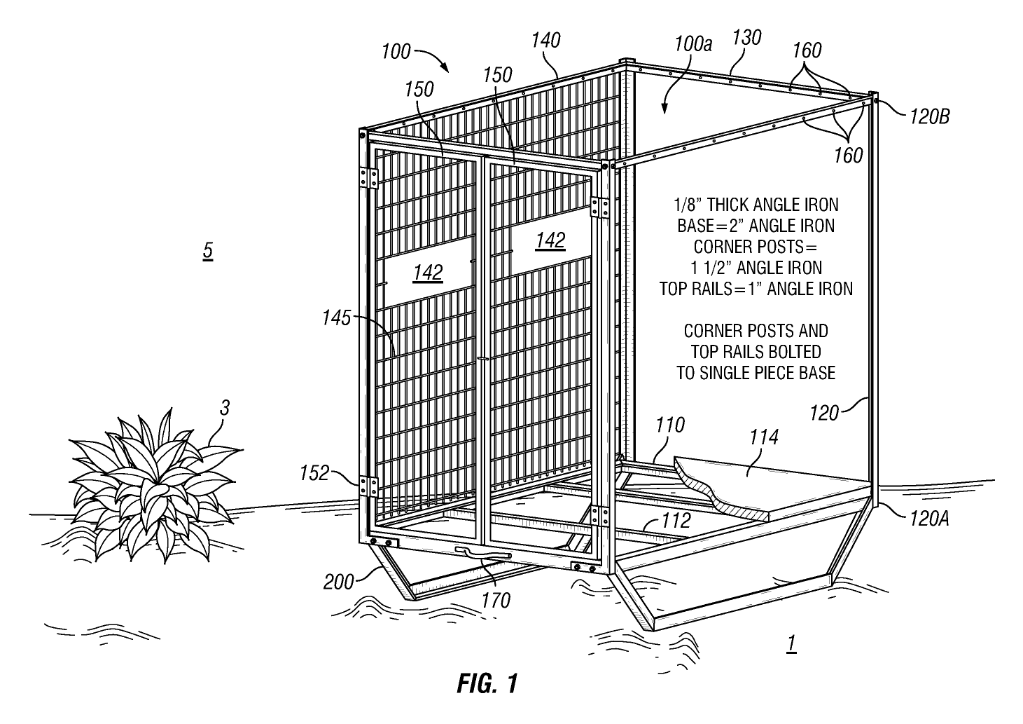

FIG. 1 illustrates an exemplary embodiment of a blind structure according to the present disclosure. In the embodiment shown, the blind 100 comprises a structure having a base 110, posts 120, rails 130, and wherein the base 110, posts 120 and rails 130 define walls 140 extending therebetween. In an exemplary configuration of the disclosure, the blind 100 comprises a skidable member 200 coupled to the base 110 and supporting blind 100. In another exemplary configuration of the disclosure, the base 110, posts 120, and rails 130 comprise retention means 160 for the walls 140. In certain instances, the walls 140 may comprise a mesh 145 extending between the base 110, posts 120 and rails 130. In another exemplary configuration of the present disclosure, at least one wall 140 may comprise a door 150.

In instances, the blind 100 comprises any three dimensional structure suitable for holding at least one person in the standing or seated position. In further instances, the blind 100 may be any polyhedral structure suitable for holding a plurality of people. In exemplary embodiments of the present disclosure, the structure of the blind is at least a rectangular prism, having at least 6 sides.

In instances, the blind 100 comprises a base 110. In exemplary configurations, the base 110 is configurable as the floor of the blind 100. In certain configurations of the disclosure, the base 110 may comprise supports 112. Alternatively, base 112 comprises a floor 114. In exemplary configurations according to the present disclosure, supports 112 extend beneath floor 114. Without limitation by any particular theory, supports 112 bear the loads of the floor 114, for example from people. In further exemplary configurations according to the present disclosure, the base 110 provides a physical barrier to dirt, debris, moisture, water, and animals between the blind 100 and the ground 1. A suitable material for floor 114 is treated plywood, for example as either a single sheet or in strips.

In instances, blind 100 comprises a plurality of posts 120. In exemplary configurations of the present disclosure, posts 120 extend vertically upwards from base 100. Without limitation by theory, posts 120 are oriented vertically away from the ground 1, and consequently vertically away from base. Alternatively, it may be understood by a person of ordinary skill in the art that posts 120 may extend at an angle from the base 110 and the ground 1. In certain configurations, the posts 120 may be disposed at corners of the base 110. Alternatively, posts 120 may be disposed along the perimeter of base 110 at regular intervals. In further instances of the present example, the post lower end 120A may be attached to base 110 and the post upper end 120B may be disposed a vertical distance thereabove.

In instances, rails 130 are coupled to the posts 120. In certain configurations of the present disclosure, rails 130 are disposed between adjacent post upper ends 120B. Without limitation by any particular theory, rails 130 connect the post upper ends 120B, and in conjunction with the posts 120 and the base 110, form the general support structure of the blind. In alternative configurations, rails 130 may be oriented at angles between a post lower end 120A and an adjacent post upper end 120B, for non-limiting example, to provide support to posts 120. In certain configurations according to the present disclosure, rails 130 are coupled to posts 120 by any suitable fastener. As shown in FIG. 1, the blind 100 is open on the top (i.e., the blind is formed without a roof or ceiling). In further alternate configurations of the present disclosure, rails 130 may provide support for a roof or other cover disposed vertically above the base 110.

In instances, walls 140 are two-dimensional structures extending laterally along the structure between adjacent posts 120, and extending vertically along the structure between the rails 130 and the base 110. Walls 140 form the sides of the blind 100 and provide the blind its shape. In instances, walls 140 provide a barrier between the blind 100A interior and the environment 5. In certain configuration according to the present disclosure, walls 140 include windows 142. In alternate configurations, walls 140 may have windows cut or removed by an end user. Without limitation by theory, windows 142 comprise an opening or void where the material of the walls 140 is not present. Alternatively, windows 142 may comprise a reversible opening in the walls 140. As maybe understood by a person of ordinary skill in the art, windows 142 provide at least partial access to the environment from the blind inside 100A. In instances, windows 142 provide a limited area of access through walls 140.

In instances, walls 140 have a significant amount of open area, including the windows 142. In exemplary configurations of the present disclosure the walls 140 comprise a mesh 145. Mesh 145 may comprise any material that has a significantly large percentage of open area or a large open area between solid or contiguous material. In instances, mesh 145 may comprise wire mesh, expanded metallic mesh, polymer mesh, plastic mesh, or other two dimension sheet materials. In exemplary configurations of the present disclosure, the mesh 145 comprises a wire mesh, such as but not limited to wire fencing mesh.

In instances, the mesh 145 is suitable for the insertion or weaving of native vegetation or plant material 3 to form walls 140 and disguise the mesh. Alternatively, mesh 145 may comprise clips or ties for retaining plant material 3 As may be understood by a person of ordinary skill, the plant material 3 comprises both a physical and visual barrier between the environment and the blind inside 100A. Additionally, plant material 3 may be used as camouflage to visually obscure the blind inside 100A as well as the overall shape of the blind 100. In further instances, the plant material 3 may partially or removably obscure the windows 142 visually, and particularly when viewed from the environment 5. In certain embodiments, native vegetation 3 is placed entirely over three walls and on the door, effectively concealing the persons inside blind 100 and concealing the wire mesh (the windows 142 being left uncovered and not obscured).

In instances, at least one wall 140 is replaced by door 150. Door 150 is any pivotable device suitable for reversible opening the blind 100 in order to access or exit the blind inside 100A. In certain instances, the door may be considered a means of making the environment 5 and the blind inside 100A continuous. In further configurations, the door 150 may have an opening arc greater than about 180 degrees. Without limitation by theory, the door 150 may be capable of opening inward and outward, with respect to the blind inside 100A. In further exemplary configurations, the door 150 has an automatic closing mechanism 152. As may be understood by a skilled artisan, an automatic closing mechanism 152 returns the door 150 to a shut position, or a position wherein the blind inside 100A is visually obscured from the environment. In instances, the automatic closing mechanism 152 may comprise a tension spring, a torsion spring, a pressure differential piston, a directional hinge, or other device known to a person of ordinary skill in the art. In alternate configurations, the door 150 may comprise a plurality of doors, such that one person may access the blind inside 100A at the same time another exits. In further configurations according to the present disclosure, door may comprise a pair of doors 150a, 150b. In further alternate configurations, the door 150 folds down to form a ramp from the ground 1 to the base 110.

In instances, the base 110 is supported vertically adjacent to a skidable member 200. In exemplary configurations according to the present disclosure, a skidable member 200 comprises a structure suitable for dragging or skidding the blind 100 across rough terrain and uneven ground 1. In further instances and as may be understood by a person or ordinary skill in the art, the skidable member 200 may be configured similar to a sled runner; that is primarily oriented in the desired direction of travel, or along the desired direction of travel. In further instances according to the present disclosure, skidable member 200 provides a vertical displacement of base 110 above ground. Without limitation by any particular theory, the vertical displacement of base 110 above the ground 1 provides improved viewing distances and provides improved isolation of base 110 from the ground 1. As may be understood by a person of ordinary skill in the art, isolating base 110 from ground 1 prevents water, mud, insect, rodent, or other material from intruding into blind inside 100A, and creating discomfort for a person. Isolating base 110 from ground 1 further provides greater ground clearance making towing blind 100 over certain rocks, logs and rough terrain possible.

In further exemplary configurations according to the present disclosure, the walls 140 are held to the laterally adjacent posts 120 and vertically along adjacent rails 130 and base 110 by retention means 160. In instances, the retention means 160 comprise any means suitable for holding a wall 140 to a supporting component of the blind 100. In exemplary instances, when the walls 140 comprise mesh 145, the retention means 160 comprise a plurality of holes disposed on or through the posts 120, rails 130, base 110, and door 150. More specifically, the retention means 160 comprise a plurality of holes that corresponding to the wire thickness of the mesh and corresponding to the wire spacing of the mesh 145. Without limitation by theory, by at least partially enclosing the wire mesh, for example the ends, in the posts 120, rails 130, base 110, and door 150, the walls are made more rigid, more durable, and in particular, less prone or likely to vibrate apart when the blind 100 is skidded into position.

In still further exemplary configurations according to the present disclosure, the base 110 is configured as a single entity or unitary structure. In non-limiting examples according to the present disclosure the base 110, supports 112, and floor 114 may be unitarily constructed. In further exemplary configurations, the base 110 and the skidable means 200 are unitarily constructed. In instances, unitarily constructed comprises a single piece, or a plurality of components attached by permanent or semi-permanent fasteners, such that the part is modular or otherwise inseparable by a user. Non-limiting examples of unitary construction include stamped steel, forged metal, weld metal, or other processes known to an ordinarily skilled artisan. Further, examples of permanent fasteners include without limitation tack welds, rivets, captive fasteners, or other permanent fastening means known to an ordinarily skilled artisan. Alternatively, non-limiting examples of semi-permanent fasteners include interlocking components, bolts and nuts, adhesives, or other semi-permanent fasteners known to an ordinarily skilled artisan. In exemplary configurations according to the present disclosure, the base 110 is constructed by a combination of the above. Without limitation by any particular theory, constructing the base 110 and the skidable means 140 as a unitary structure increases the durability of the blind 110, particularly with respect to being transported by skidding or dragging into a location.

In still further exemplary configurations according to the present disclosure, the base 110 comprises a coupler 170. Coupler 170 is any structure attached to the base 110 configured for retaining a tow hook or tow line and connecting the blind 100 to a transport means capable of traversing unpaved ground, or off-road grounds. In certain instances, the coupler 170 may comprise a receiver, a hitch, a tow hook, a tow loop, a tow cleat, a tow or jerk strap, or any other structure known to an ordinarily skilled artisan. In certain configurations according to the present disclosure the coupler 170 is a component of the base 110. Alternatively, the coupler 170 is fastened to the base 110 by one of the methods for assembly the base 110 listed previously. As may be understood by a skilled artisan, a coupler 170 having a strong connection to the bases prevents damage to the blind 100 during skidding or dragging into location by an off-road vehicle.

As described herein above, the blind 100 is configured for off-road skidable relocation behind a suitable vehicle. Examples of suitable vehicles include without limitation, a pick-up truck, a sport utility vehicle, or an all-terrain vehicle (ATV) for personal transport, such as a trike ATV, a four-wheeler ATV, a side-by-side ATV, a six-wheel ATV, a snowmobile, a swamp-buggy, or an offroad-motorcycle, without limitation. In the exemplary configuration of the present disclosure, the coupler 170 is preferably coupled to a personal ATV, such that the blind 100 may access locations that are not accessible by road going vehicles.

In further alternative configurations, at least one road axle may be coupled to skidable member 200 of the blind 100. In instances, the axle extends laterally across the blind 100. As may be understood by a person of ordinary skill, a road axle having wheels disposed at each side permits the transportation of the blind 100 along paved, gravel, or compacted dirt roads.

As will be understood, configuring blind 100, as described above and shown in FIG. 1, with base 110 supported above the ground on skidable member 200 and with coupler 170, allows blind 100 to be constructed and camouflaged at a first location (i.e., a camp site) and then towed to a second location (i.e., a hunting or wildlife viewing site). In many instances, it is more convenient to: (1) assemble blind 100 and gather native vegetation and install it on blind 100 at a campsite or other location where tools, water, shade, food, etc. are available to the builders of the blind; and (2) thereafter tow the completely-assembled and camouflaged blind to the hunting/viewing location.

While the preferred embodiments have been shown and described, modifications thereof can be made by one skilled in the art without departing from the spirit and teachings herein. The embodiments described and the examples provided herein are exemplary only, and are not intended to be limiting. Many variations and modifications of the disclosed embodiments are possible and are within the scope of the invention. Accordingly, the scope of protection is not limited by the description set out above, but is only limited by the claims which follow, that scope including all equivalents of the subject matter of the claims.

We claim:

1. A blind structure comprising:
a base, having a plurality of sides and a plurality of corners,
a plurality of rails;
a plurality of posts disposed at the plurality of base corners, and supporting the rails vertically thereabove; and
a skidable member coupled to the base; wherein the skidable member supports the base.

2. A blind structure comprising:
a base, having a plurality of sides and a plurality of corners,
a plurality of rails;
a plurality of posts disposed at the plurality of base corners, and supporting the rails vertically thereabove; and
a plurality of wire mesh sheets disposed between the posts forming a plurality of walls;
wherein the base, the plurality of rails, and the plurality of posts include retention means for the plurality of wire mesh sheets.

3. A blind structure comprising:
a base having a plurality of sides; and
a plurality of walls extending vertically from the plurality of sides;
wherein at least one wall comprises an automatically closing door.

4. A method of creating a blind structure comprising:
(a) assembling a frame;
(b) coupling said frame to a base;
(c) supporting said base on a plurality of rails;
(d) coupling a supporting mesh to said frame;
(e) covering at least a portion of said wire mesh with native vegetation.

5. The method of claim 4 further comprising towing said blind structure from a first location to a second location.

6. The method of claim 5 further comprising towing said blind structure to said second location after at least (a)-(c) have been performed at said first location.
